(19) United States
(12) Patent Application Publication
(10) Pub. No.: US 2003/0178389 A1
(43) Pub. Date: Sep. 25, 2003

(54) Method of forming via metal layers and via metal layer-formed substrate

(76) Inventor: Mitsuhiro Yuasa, Tokyo (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/362,657

(22) PCT Filed: Jun. 26, 2002
(86) PCT No.: PCT/JP02/06436

(30) Foreign Application Priority Data
Jul. 9, 2001 (JP) 2001-207869

(51) Int. Cl. C03C 25/68; C03C 15/00

(52) U.S. Cl. 216/79; 216/95

(57) ABSTRACT

A method of forming via hole metal layers, including the steps of forming via holes in a Si layer by etching an SOI substrate having a SiO₂ layer and the Si layer formed on a Si substrate in order of precedence, the via holes being extended to the SiO₂ layer, and forming the via hole metal layers in the via holes.

### TECHNICAL FIELD

The present invention generally relates to a method of forming via hole metal layers and a substrate with via hole metal layers formed therein, and more particularly, to a substrate in which via hole metal layers suitable for a three-dimensional LSI are formed.

### BACKGROUND ART

The integration of LSI is proceeding so as to add more functions to communication apparatus and so forth.

The reduction of the mounting area of electronic circuit by the improvement in the integration level of LSI is limited. The delay in signals due to the length of wiring may cause a problem. A technique in which an LSI chip is formed three dimensionally by stacking three layers is under development (see FIG. 10C).

One of the problems that need to be solved is the forming of a fine-diameter piercing via hole in wafer process.

For example, a method of forming a piercing via hole showed in FIG. 10 is studied.

A wafer 1 where a semiconductor circuit (not showed) is formed on the top face thereof is etched, and a plurality of via holes 2a-2c are formed (FIG. 10A). The time of etching is controlled, but it is generally difficult to control the etching in the depth direction. Therefore, it is difficult to control the depth dp1-dp3 of respective via holes 2a-2c.

In the case where the thickness of LSI chips is to be reduced down to about 50 μm, for example, such a problem is avoided as follows. Via hole metal layers 3 are formed by implanting conductive metal such as Cu in the plurality of via holes 2a-2c formed on the wafer 1 of which thickness is more than 50 μm; the bottom face of the wafer 1 is grinded by a grinder; if necessary, the bottom face of the wafer 1 is flattened by CMP method; and the top of each via hole metal layer 3 is protruded by etching Si (FIG. 10B). A three-dimensional LSI 5 is formed by stacking some LSI chips 4 thus formed (FIG. 10C).

However, in this case, since the bottom face of the wafer 1 (LSI chip) is physically grinded by the CMP method and so forth so as to reduce the thickness of the wafer 1 down to a desired one, the height of each via hole metal layer 3 may differ. The difference in the height of each via hole metal layer 3 may degrade the reliability of connection between LSI chips.

### DISCLOSURE OF THE INVENTION

Accordingly, it is the first object of the present invention to provide a method of forming via hole metal layers of which height are substantially equal and a substrate with such via hole metal layers formed therein.

The second object of the present invention is to provide a method of forming highly flat piercing via hole metal layers on a substrate and the substrate with such via hole metal layers formed therein.

A method of forming via hole metal layers according to the present invention includes the steps of forming via holes in a Si (Silicon) layer by etching an SOI (Silicon On Insulator) substrate having a SiO₂ (Silicon Dioxide) layer formed on a Si substrate in order of precedence, the via holes being extended to the SiO₂ layer, and forming the via hole metal layers in the via holes.

By this method, the via holes of the same depth are formed by over-etching using the SiO₂ layer as a stopper layer by selective ratio, and then, the via hole metal layers of the same height are formed.

In this case, the method may further include the steps of removing the Si substrate and removing the SiO₂ layer by etching so that a substrate that is provided with piercing via hole metal layers of the same height is obtained, wherein the face of the substrate from which the SiO₂ layer is removed is highly flat. The substrate thus obtained is suitable to a three dimensional LSI and so forth.

A method of forming via hole metal layers according to the present invention includes the steps of forming via holes in a Si layer and a SiO₂ layer by etching an SOI substrate having the SiO₂ layer and the Si layer formed on the SiO₂ layer in order of precedence, the via holes being extended to the Si substrate, and forming the via hole metal layers in the via holes.

By this method, the via holes of the same depth are formed by over-etching using the Si substrate as a stopper layer by selective ratio, and then, the via hole metal layers of the same height are formed.

In this case, the method may further include the step of removing the Si substrate by etching so that a substrate that is provided with piercing via hole metal layers of the same height is obtained, wherein the face of the substrate is highly flat. The substrate thus obtained is suitable to a three dimensional LSI and so forth. In addition, the substrate is provided with the SiO₂ layer as a protective coat.

In this case, the method may further includes the step of making the via hole metal layers protrude from the Si layer by removing the SiO₂ layer by etching. Accordingly, one can use the protrusions of the via hole metal layers as bumps of the same height.

A method of forming via hole metal layers according to the present invention includes the steps of forming via holes in an upper SiO₂ layer, an upper Si layer, and a lower Si layer by etching a double layered SOI substrate having two layers, each layer including a SiO₂ layer and a Si layer, the SiO₂ layer facing at a side of a Si substrate, the via holes being extended to the lower SiO₂ layer, and forming the via hole metal layers in the via holes.

Accordingly, the substrate provided with via hole metal layers of the same height is obtained.

In this case, the method may preferably further include the steps of removing the Si substrate and removing the lower SiO₂ layer by etching.

In addition, the method may preferably further includes the step of making the via hole metal layers protrude from the upper SiO₂ layer by removing the lower Si layer by etching.

A method of forming via hole metal layers according to the present invention may include the steps of forming via holes in an upper SiO₂ layer, an upper Si layer, a lower SiO₂ layer, and a lower Si layer by etching a double layered SOI substrate having two layers, each layer including a SiO₂ layer and a Si layer, the SiO₂ layer being at a side of a Si substrate, the via holes being extended to the Si substrate, and forming the via hole metal layers in the via holes.

In this case, the method may further include the step of removing the Si substrate.

In this case, the method may further include the step of making the via hole metal layers protrude from the lower Si layer by removing the lower SiO₂ layer by etching.

A substrate, according to the present invention, in which the via hole metal layers are formed using the above method of forming via hole metal layers.

Accordingly, the substrate with via hole metal layers formed therein is suitable for a three dimensional LSI and so forth.

### BRIEF DESCRIPTION OF THE DRAWINGS

FIGS. 1A-1D are schematic diagrams for explaining a method of forming via hole metal layers according to the first embodiment and a substrate with the via hole metal layers formed therein, wherein FIG. 1A shows a step of preparing an SOI substrate and FIG. 1D shows a step of forming via hole metal layers;

FIGS. 2A and 2B are schematic diagrams following FIGS. 1A-1D, showing steps up to a step of removing SiO₂ layer in which the forming of via hole metal layers on the substrate is completed;

FIG. 3 is a schematic diagram showing the first variation of the substrate with the via hole metal layers formed therein according to the first embodiment;

FIG. 4 is a schematic diagram showing the second variation of the substrate with the via hole metal layers formed therein according to the first embodiment;

FIG. 5 is a schematic diagram for explaining a method of forming via hole metal layers according to the second embodiment and a substrate with the via hole metal layers formed therein, wherein FIG. 5 shows the prepared SOI substrate;

FIG. 6 is a schematic diagram for explaining the method of forming via hole metal layers according to the second embodiment, wherein FIG. 6 shows the substrate in which the via hole metal layers are completely formed;

FIG. 7 is a schematic diagram showing the first variation of the substrate with the via hole metal layers formed therein according to the second embodiment;

FIG. 8 is a schematic diagram showing the second variation of the substrate with the via hole metal layers formed therein according to the second embodiment;

FIG. 9 is a schematic diagram showing the third variation of the substrate with the via hole metal layers formed therein according to the second embodiment;

FIGS. 10A-10C are schematic diagrams for explaining a method of forming via hole metal layers that is currently studied and a substrate with the via hole metal layers formed therein, wherein FIG. 10A shows a step of forming via holes and FIG. 10C shows a step of fabricating a three dimensional LSI chip by stacking substrates with via hole metal layers formed therein.

### BEST MODE FOR IMPLEMENTING THE INVENTION

A description of the best mode for implementing the method of forming via hole metal layers according to the present invention and the substrate with the via hole metal layers formed therein will be given by reference to the drawings below.

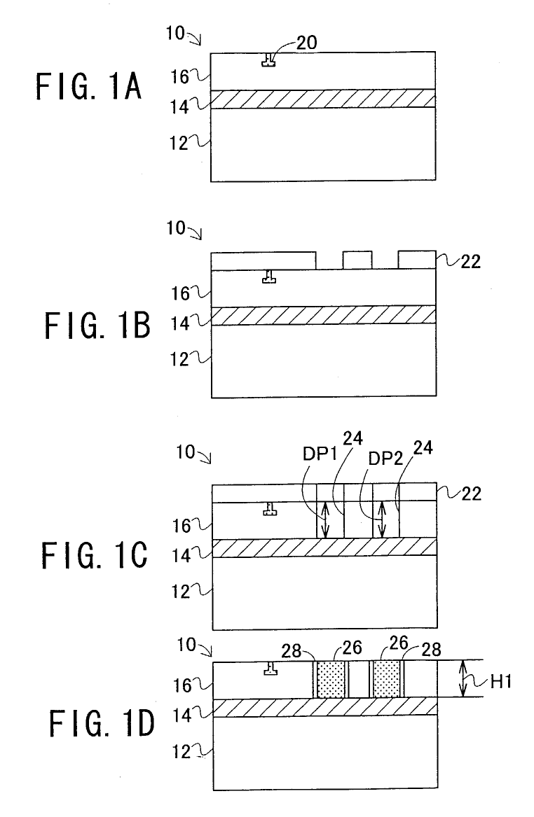

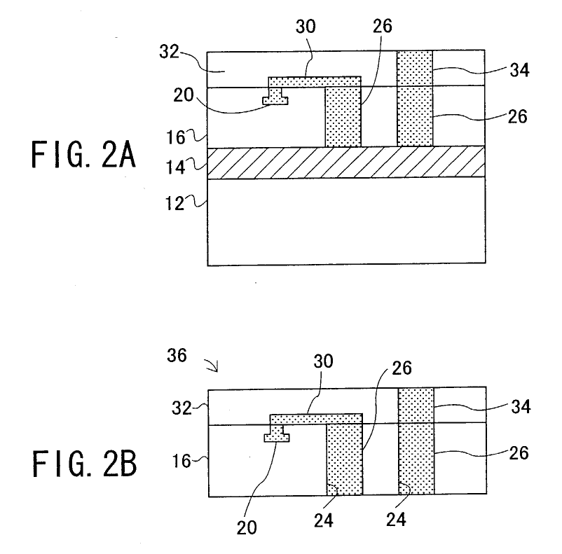

The method of forming via hole metal layers according to the first embodiment will be described by reference to FIGS. 1A-1D, 2A and 2B.

First, an SOI substrate 10 is prepared. A 1-10 μm thick SiO₂ layer 14 as a BOX layer (Buried Oxide Layer) is formed on an about 700 μm thick Si substrate 12, and an about 50 μm thick Si layer 16 is further formed on the SiO₂ layer 14. In the case of the SOI substrate showed in FIG. 1A, a device is already formed on the Si layer 16. Only an electrode 20 is showed in FIG. 1A for clarity.

Resist 22 is applied on the Si layer 16 of the SOI substrate 10 and patterned (FIG. 1B).

The resist 22 is used as a mask, and the Si layer 16 is etched by halogen gas such as HBr and Cl₂. Because of selectivity, the SiO₂ layer 14 is not etched, but via holes (holes) 24 reaching the top face of the SiO₂ layer 14 is formed in only the Si layer 16 (a step of forming via hole, FIG. 1C). Accordingly, the via holes 24 formed in the Si layer 16 have the same depth DP1 and DP2.

After stripping, Ta/TaN barrier film is formed by CVD method or PVD method so as to avoid the diffusion of implanted Cu. Then, conductive material, Cu, is implanted in the via holes 24 to form via hole metal layers 26 (a step of forming via hole metal layers showed in FIG. 1D). A plurality of via hole metal layers 26 of the same height H1 are formed on the top face of the SiO₂ layer 14, the bottom face of each via hole metal layer 26 and the top face of the SiO₂ layer 14 being on the same plane. It is desired that, before Cu is implanted, an insulating coat 28 of SiO₂, for example, be formed on the wall of each via hole 22 by CVD method and so forth as showed in FIG. 1D. The insulating coat 28 avoids the leak of current from the via hole metal layers 26. The insulating coat 28 is not showed in the drawings following FIG. 2A.

A conductor pattern 30 connecting the via hole metal layer 26 and the electrode 20, for example, is formed on the Si layer 16. Then an insulating coat 32 is formed on the Si layer 16. It is noted that a via hole metal layer 34 in connection with another via hole metal layer 26 is formed in the insulating layer 32 (FIG. 2A).

Most of the Si substrate 12 is removed by a grinder and so forth. The remainder of the Si substrate 12 is further removed by etching using halogen gas such as HBr and Cl₂ (a step of removing Si substrate). SiO₂ layer 14 is removed by wet etching or dry etching (a step of removing SiO₂ layer 14, FIG. 2B). Thus, a substrate 36 with via hole metal layers 26 formed therein is obtained.

The substrate 36 with via hole metal layers 26 formed therein fabricated by the method of forming via hole metal layers according to the first embodiment has via hole metal layers of the same height. The bottom face of the Si layer on a side where the via hole metal layers are exposed and the bottom faces of via hole metal layers are on the same plane. Accordingly, the reliability of inter-chip connection is not degraded. A preferable three dimensional LSI is obtainable by stacking the substrates 36 in which via hole metal layers 26 are provided.

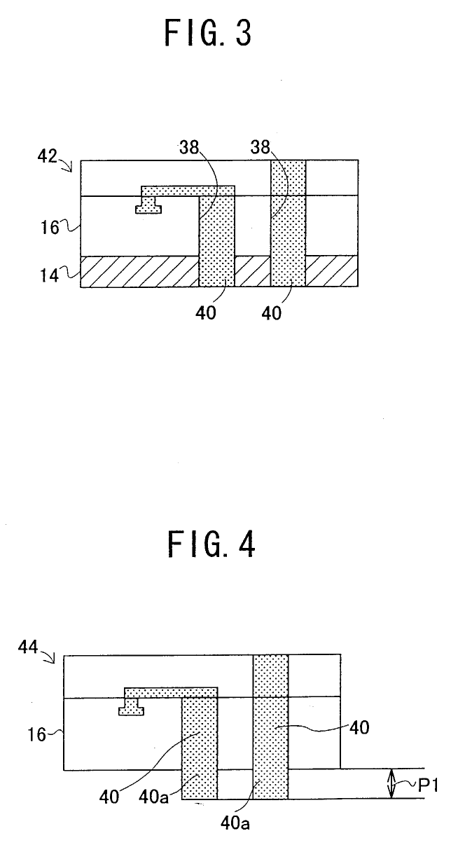

Two variations of the method of forming via hole metal layers according to the first embodiment and the substrate with the via hole metal layers formed therein will be described by reference to FIGS. 3 and 4.

The first variation differs from the method of forming via hole metal layers according to the first embodiment in the step of forming via holes as showed in FIG. 1C as follows: the Si layer 16 is etched; the SiO₂ layer 14 is etched using CF system etching gas such as CF₄, C₄F₈, C₅F₈, and C₄F₆; and via holes 38 piercing the Si layer 16 and SiO₂ layer 14 using the Si substrate 12 as a stopper layer. Then, via hole metal layers 40 are formed by following the same steps as the method of forming via hole metal layers according to the first embodiment. Si substrate 12 is removed.

A substrate 42 having SiO₂ layer 14 formed on the bottom face of the Si layer 16 and via hole metal layers 40 piercing the SiO₂ layer 14 is obtained (FIG. 3).

The substrate 42 having via hole metal layers 40 according to the first variation is provided with SiO₂ layer 14 on the bottom face of Si layer 16 as a preferable protective coat.

According to the second variation, the SiO₂ layer 14 provided on the substrate 42 having via hole metal layers 40 according to the first variation is further removed by wet etching or dry etching.

A substrate 44 having via hole metal layers of which an end 40a protrudes from the Si layer 16 (a step of protruding via hole metal layers, FIG. 4).

The substrate 44 having via hole metal layers 40 according to the second variation has the via hole metal layers of which the heights P1 of protrusion are substantially equal. In other words, the substrate 44 on which bumps (protruding electrodes) having the same height are formed can be obtained. The bottom face of the Si layer 16 of the substrate 44 is flat.

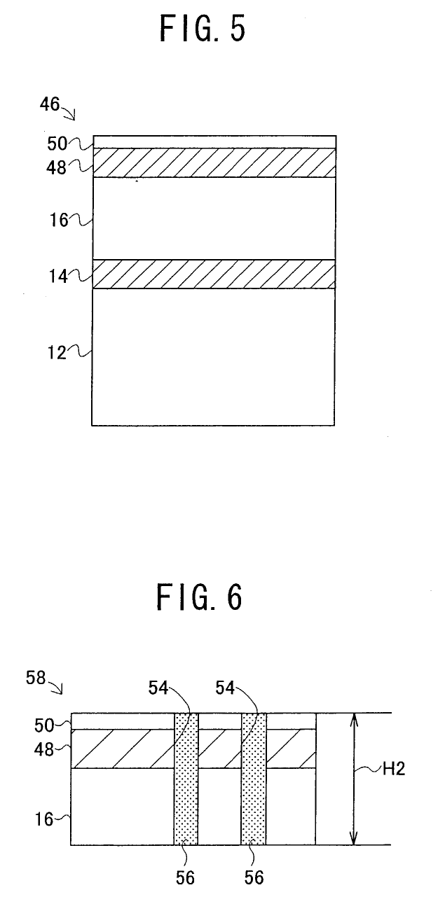

A method of forming via hole metal layers according to the second embodiment and a substrate having via hole metal layers thus formed will be described below by reference to FIGS. 5 and 6.

For the method of forming via hole metal layers according to the first embodiment, an SOI substrate 10 on which only one SiO₂ layer 14 and only one Si layer 16 are formed as showed in FIG. 1A is used. For a method of forming via hole metal layers according to the second embodiment, a double layered SOI substrate on which two SiO₂ layers and two Si layers are formed on the Si substrate instead of the SOI substrate 10.

That is, the SOI substrate 46 is provided with the first SiO₂ layer 14 and the first Si layer 16 (under layer) on the Si substrate 12, and is further provided with the second SiO₂ layer 48 of 110 μm thickness, for example, and the second Si layer 50 of 0.03-1 μm thickness, for example, (upper layer) on the first layers (FIG. 5).

Using the SOI substrate 46, via holes 54 extending to the first SiO₂ layer 14 are formed through the second SiO₂ layer 48, the second Si layer 50, and the first Si layer 16 by following substantially the same steps as the method of forming via hole metal layers according to the first embodiment (a step of forming via hole metal layers). The Si substrate 12 and the first SiO₂ layer 14 are removed (a step of removing Si substrate and a step of removing SiO₂ layer).

As described above, the via hole metal layers 56 of the same height H2 are formed, and the substrate 58 having the via hole metal layers of which the bottom face of the Si layer 16 is highly flat (FIG. 6). Since the substrate with the via hole metal layers formed therein is provided with the SiO₂ layer 48, devices (not showed) formed in the Si layer 50 on the SiO₂ layer 48 can operate at a high speed with low power consumption.

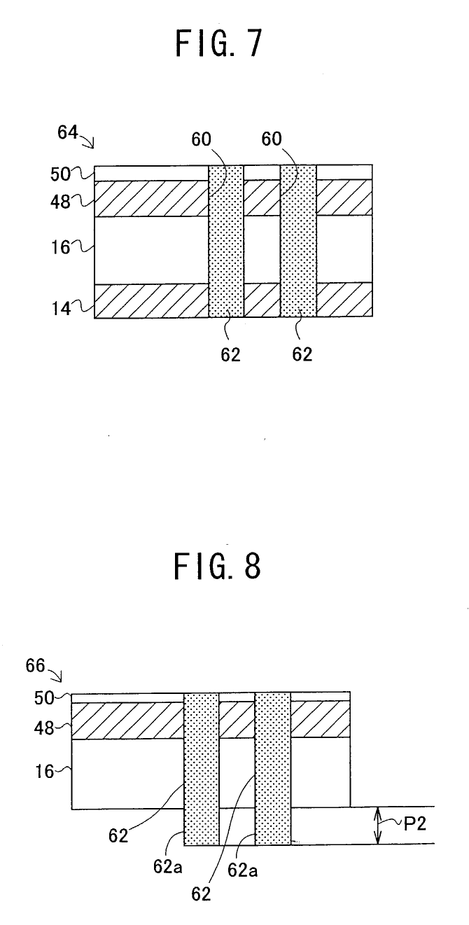

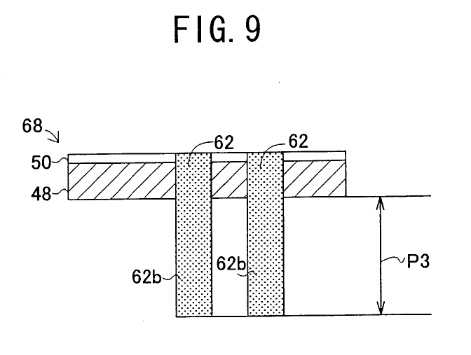

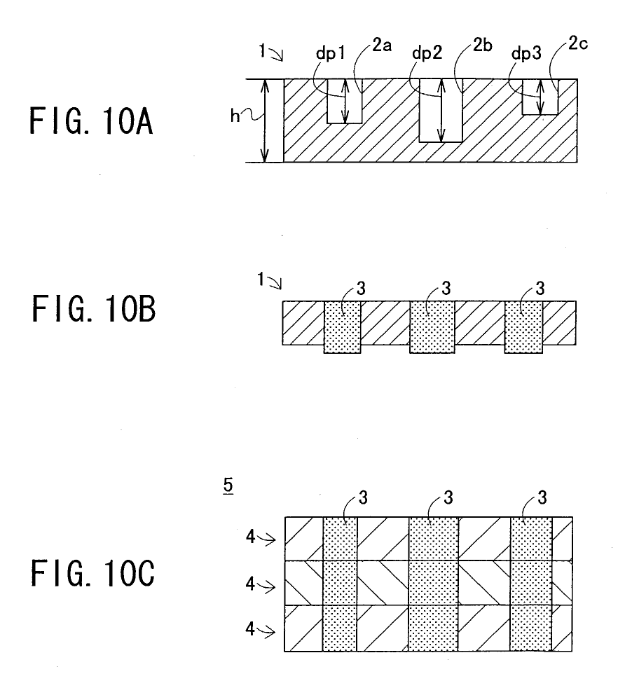

Three variations of the method of forming via hole metal layers according to the second embodiment will be described by reference to FIGS. 7-9.

In the first variation, the above SOI substrate 46 is processed in substantially the same manner as the method of forming via hole metal layers according to the second embodiment. In the same manner as the first variation (see FIG. 3) of the method of forming via hole metal layers according to the first embodiment, via holes 60 piercing the SiO₂ layer 14 and the Si layer 16 of the first layer and the SiO₂ layer 48 and the Si layer 50 of the second layer are formed using the Si substrate 12 as a stopper layer (a step of forming via holes); via hole metal layers 62 are further formed (a step of forming via hole metal layers); and then, the Si substrate 12 is removed.

By the above process, one can obtain the substrate 64 having double BOX layers of the SiO₂ layers 14 and the SiO₂ layers 50 with via hole metal layers formed therein, the via hole metal layers being of the same height, and the bottom face of the substrate 64 being highly flat (FIG. 7).

In the second variation, the substrate 64 with via hole metal layers formed therein according to the first variation is used, but the SiO₂ layer 14 is removed by wet etching or dry etching.

By the above process, one can obtain a substrate 66 with via hole metal layers formed therein, the end 62a of each via hole metal layers 62 protruding form the Si layer 16 (a step of making via hole metal layers protruding, FIG. 8).

The substrate 66 with via hole metal layers formed therein according to the second variation is provided with via hole metal layers 62 of which the height P2 of the protrusion is substantially equal. In other words, one can obtain the substrate 66 having bumps (protruding electrodes) of the same height. The bottom face of the Si layer 16 of the substrate 66 is highly flat.

In the third variation, the Si layer 16 of the substrate 66 with via hole metal layers formed therein is removed by wet etching or dry etching.

By the above process, the height P3 of the protrusion of the end 62b of the via hole metal layers 62 can be adjusted independently from the thickness of the SiO₂ layer 14.

### INDUSTRIAL APPLICABILITY

The method of forming via hole metal layers according to the present invention includes the steps of forming via holes in a Si layer by etching an SOI substrate, the via holes being extended to said SiO₂ layer, and forming the via hole metal layers in the via holes. Accordingly, the via hole metal layers of the same height are obtained.

The method of forming via hole metal layers according to the present invention further includes the steps of removing the Si substrate and removing the SiO₂ layer by etching. Accordingly, a substrate that is provided with piercing via hole metal layers of the same height is obtained, wherein the face of the substrate from which the SiO₂ layer is removed is highly flat. The substrate thus obtained is suitable to a three dimensional LSI and so forth.

In addition, the method of forming via hole metal layers according to the present invention includes the steps of forming via holes in a Si layer and a SiO₂ layer, the via holes being extended to the Si substrate, forming the via hole metal layers in the via holes, and removing the Si substrate. Accordingly, the substrate is provided with the SiO₂ layer as a protective coat.

The method of forming via hole metal layers according to the present invention further includes the step of making the via hole metal layers protrude from the Si layer by removing the SiO₂ layer by etching. Accordingly, one can use the protrusions of the via hole metal layers as bumps of the same height.

The method of forming via hole metal layers according to the present invention includes the steps of forming via holes in an upper SiO₂ layer, an upper Si layer, and a lower Si layer by etching a double layered SOI substrate having two layers, each layer including a SiO₂ layer and a Si layer, the via holes being extended to the lower SiO₂ layer, and forming the via hole metal layers in the via holes. Accordingly, the substrate provided with via hole metal layers of the same height is obtained. One can obtain SOI devices of improved electrical properties by this method.

The substrate in which the via hole metal layers are formed using the above method of forming via hole metal layers according to the present invention is obtained. Accordingly, the substrate with via hole metal layers formed therein is suitable for a three dimensional LSI and so forth.

What is claimed is:

1. A method of forming via hole metal layers, comprising the steps of:
forming via holes in a Si layer by etching an SOI substrate having a SiO₂ layer and said Si layer formed on a Si substrate in order of precedence, said via holes being extended to said SiO₂ layer; and
forming said via hole metal layers in said via holes.

2. The method as claimed in claim 1, further comprising the steps of:
removing said Si substrate; and
removing said SiO₂ layer by etching.

3. A method of forming via hole metal layers, comprising the steps of:
forming via holes in a Si layer and a SiO₂ layer by etching an SOI substrate having said SiO₂ layer and said Si layer formed on a Si substrate in order of precedence, said via holes being extended to said Si substrate; and
forming said via hole metal layers in said via holes.

4. The method as claimed in claim 3, further comprising the step of removing said Si substrate by etching.

5. The method as claimed in claim 4, further comprising the step of making said via hole metal layers protrude from said Si layer by removing said SiO₂ layer by etching.

6. A method of forming via hole metal layers, comprising the steps of:
forming via holes in an upper SiO₂ layer, an upper Si layer, and a lower Si layer by etching a double layered SOI substrate having two layers, each layer including a SiO₂ layer and a Si layer, said SiO₂ layer facing at a side of a Si substrate, said via holes being extended to said lower SiO₂ layer; and
forming said via hole metal layers in said via holes.

7. The method as claimed in claim 6, further comprising the steps of:
removing said Si substrate; and
removing said lower SiO₂ layer by etching.

8. The method as claimed in claim 7, further comprising the step of making said via hole metal layers protrude from said upper SiO₂ layer by removing said lower Si layer by etching.

9. A method of forming via hole metal layers, comprising the steps of:
forming via holes in an upper SiO₂ layer, an upper Si layer, a lower SiO₂ layer, and a lower Si layer by etching a double layered SOI substrate having two layers, each layer including a SiO₂ layer and a Si layer, said SiO₂ layer facing at a side of a Si substrate, said via holes being extended to said Si substrate; and
forming said via hole metal layers in said via holes.

10. The method as claimed in claim 9, further comprising the step of removing said Si substrate.

11. The method as claimed in claim 10, further comprising the step of making said via hole metal layers protrude from said lower Si layer by removing said lower SiO₂ layer by etching.

12. A substrate in which the via hole metal layers are formed using the method as claimed in claim 1.

13. A substrate in which the via hole metal layers are formed using the method as claimed in claim 3.

14. A substrate in which the via hole metal layers are formed using the method as claimed in claim 6.

15. A substance in which the via hole metal layers are formed using the method as claimed in claim 9.
